(19) United States
(12) Patent Application Publication
(10) Pub. No.: US 2010/0289811 A1
(43) Pub. Date: Nov. 18, 2010

(54) Dynamic Backlight Control System and Method with Color-Temperature Compensation

(76) Inventors: SHING-CHIA CHEN, TAINAN (TW); LIN-KAI BU, TAINAN (TW)

Correspondence Address: STOUT, UXA, BUYAN & MULLINS LLP, 4 VENTURE, SUITE 300, IRVINE, CA, 92618, US

(21) Appl. No.: 12/464,809

(22) Filed: May 12, 2009

(51) Int. Cl. G09G 3/36; G09G 5/02

(52) U.S. Cl. 345/589; 345/102

(57) ABSTRACT

A dynamic backlight control system and method with color-temperature compensation are disclosed. A dynamic backlight control unit dynamically controls brightness of a backlight unit according to image data. A color-temperature model is provided for mapping the brightness of the backlight unit into color temperature. A color-temperature compensation unit then compensates the image data according to the mapped color temperature.

### BACKGROUND OF THE INVENTION

1. Field of the Invention

The present invention generally relates to dynamic backlight control, and more particularly to a dynamic backlight control system and method with color-temperature compensation.

2. Description of the Prior Art

Backlight is commonly used to illuminate a flat panel display, such as a liquid crystal display (LCD), from the back or side of the flat panel display. Light sources of the backlight may be cold cathode fluorescent lamp (CCFL), light-emitting diode (LED), or other types of light sources.

A constant backlight is one that outputs even and constant light no matter how the image data or the ambient light has been changed. The constant backlight has a disadvantage, among others, of light leakage of the display caused by the backlight when the pixels of the display are in dark level (“0”), which results in low dynamic contrast.

In order to alleviate this disadvantage, a dynamic backlight (DBL) has been proposed in the past to dynamically or adaptively adjust (overall or respective portions of) the backlight luminance in accordance with image data characteristics (or statistics) or the ambient light. For example, when the image is bright the backlight outputs high luminance, and when the image is dark the backlight is dimmed, thereby reducing light leakage. Accordingly, the dynamic backlight has a higher dynamic contrast than the constant backlight. Further, the dynamic backlight reduces power consumption as compared to the constant backlight.

On the other hand, as the backlight is dynamically adjusted, the image data are compensated, when required, to result in a better display with higher quality than those without compensation. An example of brightness compensation is disclosed in U.S. Pat. No. 7,411,636, entitled “Stereoscopic Liquid Crystal Display (LCD) with Polarization Method” by Adiel Abileah, the disclosure of which is hereby incorporated by reference.

A general system block diagram of a prior-art backlight control system 1 is shown in FIG. 1 to include a backlight control unit 10 which controls a backlight unit (BLU) 12. The backlight control unit 10, which can be a DBL control unit, also acts to compensate the image data to result in compensated image data.

Even when image data can be compensated using the above brightness compensation technique, color temperature characteristics of the image still are not satisfactorily maintained primarily because of color temperature characteristics in the conventional backlight control system being characterized according to the full backlight. Therefore, color temperature is normally constant with changes in the backlight being disregarded, leading to the quality of the image display being disadvantageously affected and poorly maintained.

For the reason that conventional backlight control systems have not satisfactorily provided high quality image displays, a need has arisen to propose a novel scheme that affords arriving at desired color temperature characteristics while maintaining the favorable advantages of backlight control.

### SUMMARY OF THE INVENTION

In view of the foregoing, it is an object of the present invention to provide an architecture of color-temperature compensation companioned with dynamic backlight control, such that the required color temperature characteristics and the dynamic backlight control can both be attained without sacrificing the quality of image display.

According to one embodiment, a dynamic backlight control unit dynamically controls brightness of a backlight unit according to image data. A color-temperature model is provided for mapping the brightness of the backlight unit (e.g., represented by a backlight control signal) into color temperature (e.g., represented by color coordinates). A color-temperature compensation unit then compensates the image data according to the mapped color temperature (e.g., the color coordinates).

### BRIEF DESCRIPTION OF THE DRAWINGS

FIG. 1 shows a system block diagram of a conventional backlight control system;

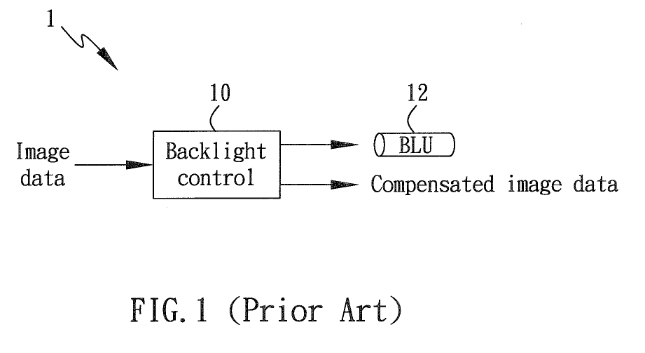

FIG. 2 shows a system block diagram of a dynamic backlight control (DBLC) system with color-temperature compensation according to one embodiment of the present invention; and

FIG. 3 shows a flow diagram of a dynamic backlight control (DBLC) method with color-temperature compensation according to one embodiment of the present invention.

### DETAILED DESCRIPTION OF THE INVENTION

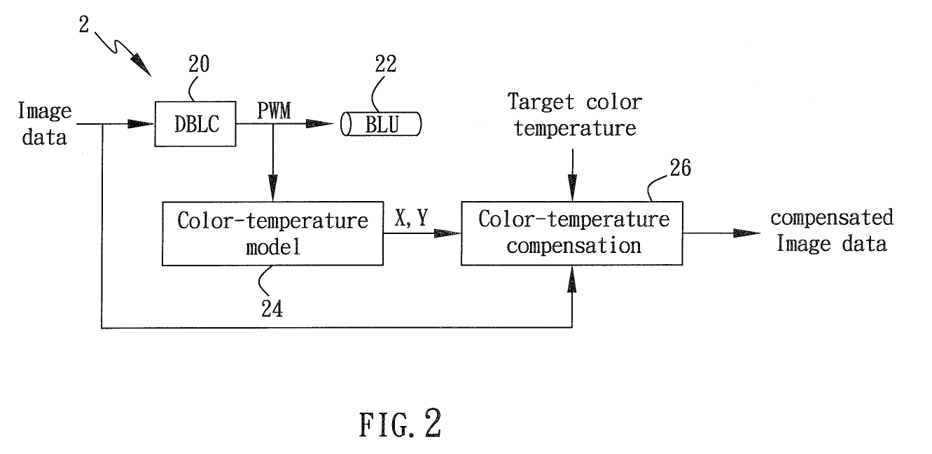

With reference to FIG. 2, a dynamic backlight control (DBLC) system 2 with color-temperature compensation is shown in block diagram form according to one embodiment of the present invention. The term “color temperature” in this specification is defined according to the definition or definitions in the field of color science. For example, the color temperature, usually in kelvin (K), of a light source is determined by comparing its chromaticity with that of an ideal black-body radiator.

A dynamic backlight control (DBLC, also known as content adaptive backlight control or CABC) unit 20 dynamically or adaptively adjusts (overall or respective portions of) the backlight luminance of a backlight unit (BLU) 22 in accordance with image data characteristics (or statistics) or the ambient light. For example, when the image is bright (e.g., high average brightness of the image data) the backlight outputs high luminance, and when the image is dark the backlight is dimmed. A system with such dynamic backlight control normally has a higher dynamic contrast than a system with constant backlight.

The backlight unit 22 may normally be controlled by the dynamic backlight control unit 20 through a backlight control signal such as, but not limited to, a pulse width modulation (PWM) control signal (denoted in the figure as PWM), which has active duty (e.g., an active duty cycle) proportional to the target luminance of the backlight unit 22.

The backlight control signal (e.g., PWM) is also fed to color-temperature model 24, which involves (e.g., implements), in general, a relationship between the brightness of the backlight unit 22 and the color temperature. In other words, the color-temperature model 24 maps the brightness of the backlight unit 22 into the (e.g., to a) color temperature. Specifically, in the embodiment, the brightness may be represented by the corresponding backlight control signal PWM, and the color temperature may be represented and measured by a chromaticity space suitable for describing the color temperature. For example, the color temperature may be represented by color coordinates X, Y in a XY chromaticity space (or simply the color space). It is appreciated by those skilled in the art that other color space, such as XYZ color space, may be used instead. The representation or model of the relationship between the brightness (e.g., PWM) and the color temperature (e.g., color coordinates X, Y) may be built or constructed from experimental data collection that is stored as a lookup table (LUT). Alternatively, the model may be established according to suitable algorithm.

Accordingly, the color-temperature model 24 outputs, for example, color coordinates X, Y representing the corresponding color temperature of (e.g., in accordance with) the input, for example, backlight control signal PWM representing the brightness of the backlight unit 22.

Subsequently, the image data are compensated by a color-temperature compensation unit 26 according to the color coordinates X, Y from the color-temperature model 24. In the embodiment, the compensation may be performed, for example, by changing the color components R, G, B (red, green, blue) of the image data until the input color coordinates X, Y converge at/to a target color temperature, which may be a constant or may be dynamically adjusted. The target color temperature may be set in the system 2, or may be inputted, for example, by a user. The color-temperature compensation may be built or constructed from experimental data collection that is stored as a lookup table (LUT). Alternatively, the color-temperature compensation may be established according to suitable algorithm.

According to the embodiment disclosed above, the target color temperature of the image display may be maintained even though the brightness of the backlight unit 22 is dynamically changing, thereby achieving better and more precise color performance. It is worthy of noting that, in addition to the color temperature compensation disclosed in the embodiment, brightness compensation as mentioned and referenced in the “Description of the Prior Art” may be additionally performed on the image data.

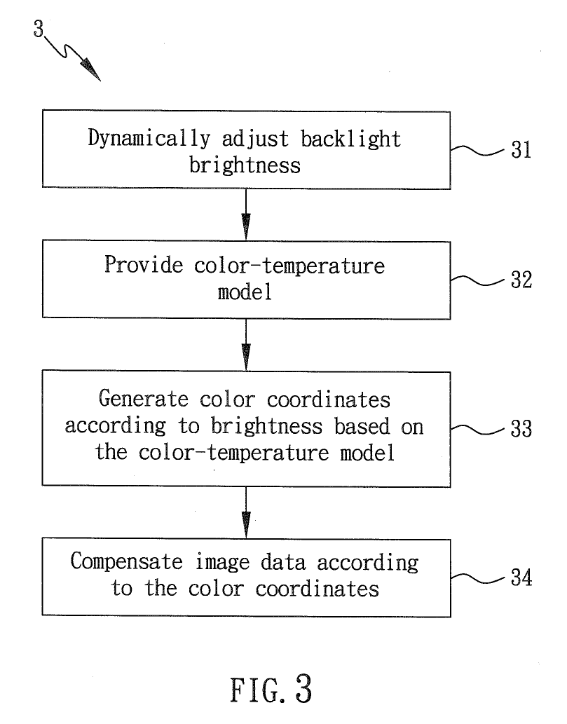

FIG. 3 shows a flow diagram of a dynamic backlight control (DBLC) method 3 with color-temperature compensation according to one embodiment of the present invention. In step 31, the backlight brightness is dynamically adjusted according to image data characteristics (or statistics). For example, when the image is bright the backlight brightness increases, and when the image is dark the backlight brightness, accordingly, decreases.

A color-temperature model is provided, in step 32, to describe the relationship between the backlight brightness and the color temperature. In the embodiment, the backlight brightness may be represented by a backlight control signal PWM, and the color temperature may be represented by a suitable chromaticity space, such as XY chromaticity space (or simply the color space). The representation or model may be built or constructed from experimental data collection that is stored as a lookup table (LUT). Alternatively, the model may be established according to a suitable algorithm. Afterwards, in step 33, color coordinates X, Y representing the corresponding color temperature are generated in accordance with the backlight brightness based on the provided color-temperature model.

Subsequently, in step 34, the image data are compensated according to the generated color coordinates X, Y. In the embodiment, the compensation may be performed, for example, by changing the color components R, G, B (red, green, blue) of the image data until the color coordinates X, Y converge at a target color temperature, which may be a constant or may be dynamically adjusted. The color-temperature compensation may be built or constructed from experimental data collection that is stored as a lookup table (LUT). Alternatively, the color-temperature compensation may be established according to a suitable algorithm.

Although specific embodiments have been illustrated and described, it will be appreciated by those skilled in the art that various modifications may be made without departing from the scope of the present invention, which is intended to be limited solely by the appended claims.

What is claimed is:

1. A dynamic backlight control system with color-temperature compensation, the system comprising:
a dynamic backlight control unit for dynamically controlling brightness of a backlight unit according to image data;
color-temperature model means for mapping the brightness of the backlight unit into color temperature; and
a color-temperature compensation unit for compensating the image data according to the mapped color temperature.

2. The system of claim 1, wherein the dynamic backlight control unit generates a backlight control signal representing corresponding brightness of the backlight unit.

3. The system of claim 2, wherein the backlight control signal is a pulse width modulation (PWM) control signal, which has active duty proportional to the brightness of the backlight unit.

4. The system of claim 2, wherein the color-temperature model means generates color coordinates representing the mapped color temperature according to the brightness of the backlight unit.

5. The system of claim 4, wherein the color coordinates are defined by a XY chromaticity space.

6. The system of claim 4, wherein the color coordinates and the backlight control signal are stored as a lookup table (LUT).

7. The system of claim 4, wherein the color-temperature compensation unit changes color components of the image data until the color coordinates converge at a target temperature.

8. The system of claim 7, wherein color components R, G, B (red, green, blue) of the image data are changed by the color-temperature compensation unit.

9. The system of claim 1, wherein the backlight unit is dynamically controlled according to statistics of the image data.

10. The system of claim 9, wherein the brightness of the backlight unit is decreased when average brightness of the image data is lowered, and the brightness of the backlight unit is increased when average brightness of the image data is raised.

11. A dynamic backlight control method with color-temperature compensation, the method comprising:
dynamically controlling backlight brightness according to image data;
providing a color-temperature model for mapping the backlight brightness into color temperature; and
compensating the image data according to the mapped color temperature.

12. The method of claim 11, wherein the step of controlling the backlight brightness includes generation of a backlight control signal to represent corresponding backlight brightness.

13. The method of claim 12, wherein the backlight control signal is a pulse width modulation (PWM) control signal, which has active duty proportional to the backlight brightness.

14. The method of claim 12, wherein the color-temperature model generates color coordinates representing the mapped color temperature according to the backlight brightness.

15. The method of claim 14, wherein the color coordinates are defined by a XY chromaticity space.

16. The method of claim 14, wherein the color coordinates and the backlight control signal are stored as a lookup table (LUT).

17. The method of claim 14, wherein the step of compensating the image data comprises changing color components of the image data until the color coordinates converge at a target temperature.

18. The method of claim 17, wherein color components R, G, B (red, green, blue) of the image data are changed in the step of compensating the image data.

19. The method of claim 11, wherein the backlight brightness is dynamically controlled according to statistics of the image data.

20. The method of claim 19, wherein the backlight brightness is decreased with decreasing brightness of the image data and is increased with increasing average brightness of the image data.
